(19) United States
(12) Patent Application Publication
(10) Pub. No.: US 2003/0213632 A1
(43) Pub. Date: Nov. 20, 2003

(54) Swing arm for an electric motor driven vehicle

(75) Inventor: Ely Schless, Ashland, OR (US)

Correspondence Address: Craig A. Gelfound, McDermott, Will & Emery, 2049 Century Park East, Suite 3400, Los Angeles, CA, 90067, US

(73) Assignee: Electric Cycle Company

(21) Appl. No.: 10/150,485

(22) Filed: May 16, 2002

(51) Int. Cl. B62K 25/28

(52) U.S. Cl. 180/227; 180/220; 280/284

(57) ABSTRACT

An electric motor driven cycle having a rear wheel, an electric motor configured to deliver power to the rear wheel, and a swing arm coupled between the electric motor and the rear wheel. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or the meaning of the claims.

### BACKGROUND

1. Field

The present invention relates to power driven cycles, and more specifically, to a swing arm configuration for electric motor driven cycles.

2. Background

Conventional electric motor driven cycles generally include a frame suspended between a front and rear wheel. The rear suspension system typically includes a swing arm connecting the rear wheel to the frame and a shock absorber to dampen movement between the swing arm and the frame during operation. A belt drive system can be used to deliver power from an electric motor to the to rear wheel. An idler tensioner is often used to regulate the tension of the drive belt as the swing arm moves in response to sudden bumps in the road. The idler tensioner can be implemented with an adjustable pulley which can move up and down to push the middle of the unloaded part of the drive belt out of a straight line to take up slack. The problem is that the idler tensioner typically has the highest failure rate of any component in the belt drive system. Accordingly, increased reliability can be achieved if the idler tensioner could be eliminated. In addition, the efficiency of the belt drive system can be enhanced by eliminating an extra moving part.

### SUMMARY

In one aspect of the present invention, an electric motor driven cycle includes a rear wheel, an electric motor configured to deliver power to the rear wheel, and a swing arm coupled between the electric motor and the rear wheel.

In another aspect of the present invention, an electric motor driven cycle includes a rear wheel, an electric motor, means for transmitting power from the electric motor to the rear wheel, and a swing arm coupled between the electric motor and the rear wheel.

In yet another aspect of the present invention, an electric motor driven cycle includes a rear wheel, an electric motor configured to deliver power to the rear wheel, and a swing arm cantilevered from the electric motor and supporting the rear wheel.

It is understood that other embodiments of the present invention will become readily apparent to those skilled in the art from the following detailed description, wherein it is shown and described only exemplary embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings, wherein:

FIG. 1 is a perspective view of an exemplary electric motor driven cycle;

FIG. 2A is a side view illustrating an exemplary mounting configuration for a swing arm;

FIG. 2B is a side view illustrating an alternative exemplary mounting configuration for a swing arm;

FIG. 3 is a cross-section top view showing an exemplary mounting configuration of a swing arm between an electric motor drive shaft and a rear wheel axle; and

FIG. 4 is a side view of an exemplary electric motor driven cyclic with a cosmetic overlay around the frame.

### DETAILED DESCRIPTION

The detailed description set forth below in connection with the appended drawings is intended as a description of exemplary embodiments in which the present invention can be practiced. The term “exemplary” used throughout this description means “serving as an example, instance, or illustration,” and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well-known structures and devices are shown generally in order to avoid obscuring the concepts of the present invention.

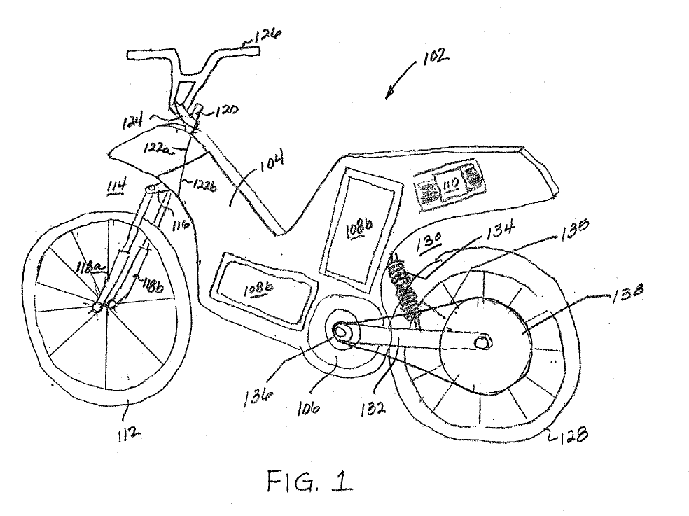

FIG. 1 is a perspective view of an electric motor driven cycle. The electric motor driven cycle 102 is based on a fully suspended and dampened monocoque frame design. A monocoque frame is a type of construction in which the outer surface bears all or a major portion of the stresses. The monocoque frame 104 can be formed as a unitary structure with one or more compartments to house the internal components of the electric motor driven cycle 102. The internal components include an electric motor 106 powered by dual batteries 108a and 108b, and a battery charger 110 to periodically charge the batteries 108a and 108b. Alternatively, the frame can be a conventional tube design such as a diamond or cross frame.

The frame 104 can be coupled to a front wheel 112 with a front fork assembly 114. The front fork assembly 114 includes a bifurcated member 116 with right and left spring loaded damping tubes 118a and 118b extending downward to form a front fork. The axle of the front wheel 112 can be inserted into the front fork. A steered tube 120 extending upward from the center of the bifurcated member 116 can be rotatably inserted through the frame 104 with upper and lower bearings (not shown). Right and left cross-members 122a and 122b can be secured to the frame 104 to prevent buckling due to compressive loading between the two bearing points. A clamp 124 can be used to couple the steered tube 120 to a handle bar 126.

Power can be delivered to a rear wheel 128 with a belt drive assembly between the electric motor 106 and the rear wheel 128. A drive belt 135 can be connected between a toothed pulley 136 at the end of the motor drive shaft and a toothed drive wheel 138 extending from the rear wheel axle. The toothed configuration of both the pulley and drive wheel tends to reduce slippage during rapid accelerations and decelerations. A drive belt can be used instead of a drive chain in applications where noise suppression is desirable.

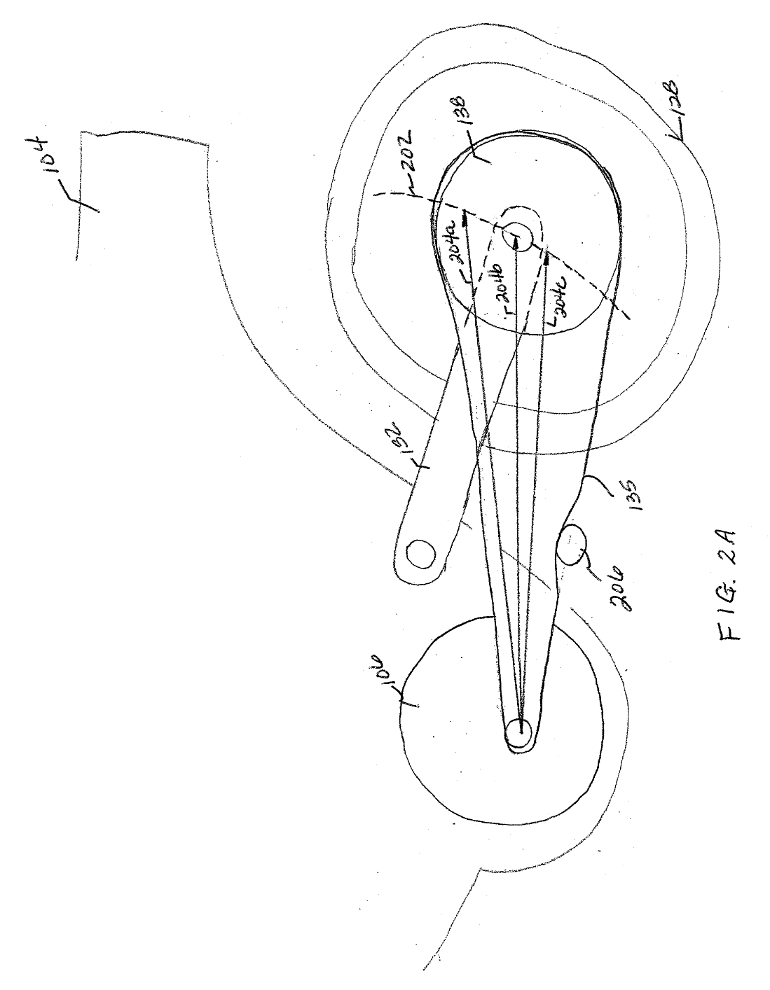

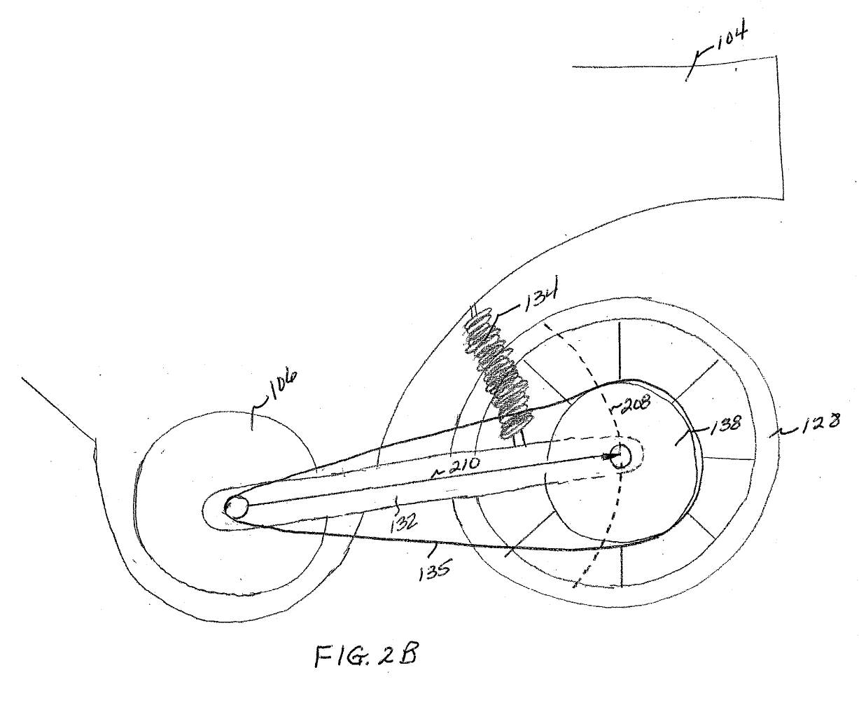

A swing arm 132 can be used to couple the rear wheel 128 to the frame 104. A shock absorber 134 can be coupled between the swing arm 132 and the frame 104 to absorb the energy produced by sudden bumps in the road. FIGS. 2A and 2B illustrate two exemplary mounting configurations with different frame attachment points. In the first case shown in FIG. 2A, the swing arm 132 is attached to the frame 104 above the electric motor 106. In this configuration, the rear wheel axle follows a path along an arc 202 defined by a radius equal to the length of the swing arm 132 as the rear wheel 128 encounters bumps in the road during operation. This causes the radial length 204a-c between the electric motor drive shaft and the rear wheel axle to change accordingly. As a result, the drive belt 135 pulls taut when the rear wheel 128 moves upward and loosens up when the rear wheel 128 moves downward. An idler tensioner 206 can be used to regulate the belt tension.

In the second case shown in FIG. 2B, the frame attachment point for the swing arm 132 is the electric motor drive shaft. In this configuration, the rear wheel axle again follows a path along an arc 208 defined by the radius of the swing arm 132 as the rear wheel 128 encounters bumps in the road during operation. However, since the frame attachment point for the swing arm 132 is concentric with the electric motor drive shaft, the radial length 210 between the electric motor drive shaft and the rear wheel axle remains unchanged with movement of the rear wheel 128. As a result, the belt tension remains constant eliminating the need for the idler tensioner.

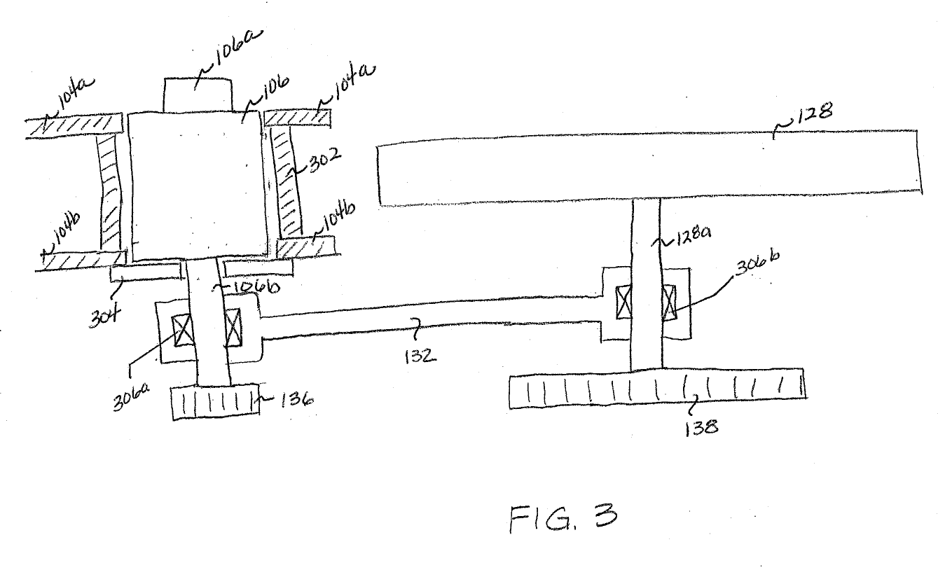

FIG. 3 is a cross-section top view showing the mounting of the swing arm between the electric motor drive shaft and the rear wheel axle. The electric motor 106 can be held between the two frame members 104a and 104b with a motor support tube 302 bolted to the frame 104. The back end 106a of the electric motor extends outward through an opening in one frame member 104a. The drive shaft 106b of the electric motor 106 extends outward through an opening in the other frame member 104b. A motor support ring 304 can be bolted to the electric motor 106 to achieve a face mount.

The toothed pulley 136 can be connected to the distal end of the drive shaft 106b. The drive belt (not shown) can be connected between the toothed pulley 136 and the toothed drive wheel 138 at the distal end of the rear wheel axle 128a. One end of the swing arm 136 can be connected to the drive shaft 106b through a front bearing 306a. The other end of the swing arm 136 can be connected to the rear wheel axle 128a through a rear bearing 128b. The drive shaft 106b should be sufficiently sized to support the swing arm 132. A drive shaft with a diameter between ⅝″and ⅞″is a good choice, however, other shaft diameters may be used depending on the particular design requirements and performance tradeoffs ascertained by the skilled artisan.

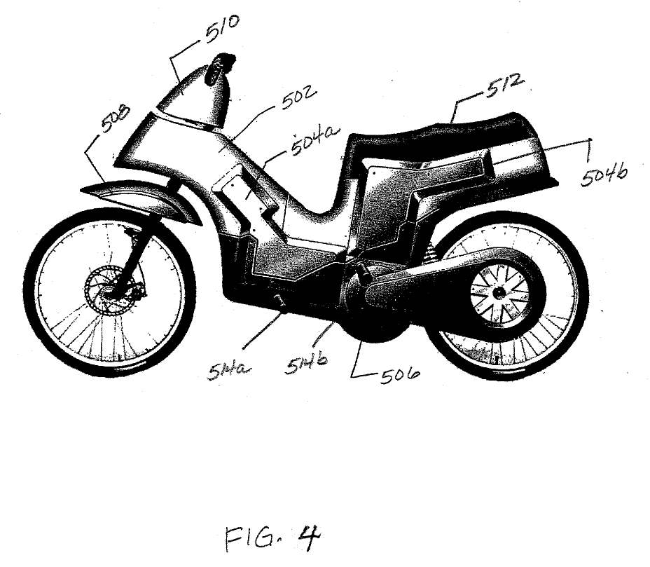

FIG. 4 is a side view of an exemplary electric motor driven cyclic with a cosmetic overlay around the frame. The overlay 402 can be plastic or any other suitable material. The use of a cosmetic overlay allows various overlay designs to be used without having to modify the frame. This approach may provide a very economical solution to support the evolution of aesthetic designs as the electric motor driven cycle industry continues to expand its penetration into the marketplace. The overlay 402 may include one or more bulges 404a and 404b to support the internal components of electric motor driven cycle. A drive belt and swing arm cover 406 in combination with the overlay 402 gives the electric motor driven cycle an overall aesthetically pleasing look.

The electric motor driven cycle 102 may also include a front fender 408 to house the bifurcated member 116 of the front fork assembly 114 (see FIG. 1). A pod 410 can be used to house the clamp 124 connection between the steered tube 120 and the handle bar 126 (see FIG. 1). The pod 410 may also be used to carry various displays and controls depending on the particular design requirements and the intended consumer market. The pod 410 may also provide a convenient surface to support a headlight (not shown). The electric motor driven cycle 102 may also include a passenger seat 412 and front and rear foot pegs 414a and 414b.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An electric motor driven cycle, comprising:
a rear wheel;
an electric motor configured to deliver power to the rear wheel; and
a swing arm coupled between the electric motor and the rear wheel.

2. The electric motor driven cycle of claim 1 wherein the electric motor comprises a drive shaft and the rear wheel comprises an axle, the swing arm being coupled between the drive shaft and the axle.

3. The electric motor driven cycle of claim 2 wherein the electric motor further comprises a pulley at a distal end of the drive shaft, and the rear wheel further comprises a drive wheel at a distal end of the axle, the electric motor driven cycle further comprising means for transmitting power from the pulley and to drive wheel.

4. The electric motor of claim 3 wherein the means for transmitting power from the pulley to the drive wheel comprises a drive belt.

5. The electric motor driven cycle of claim 1 further comprising a frame supporting the electric motor.

6. The electric motor driven cycle of claim 5 further comprising a shock absorber coupled between the frame and the swing arm.

7. The electric motor driven cycle of claim 5 further comprising a front wheel, the frame being suspended between the front and rear wheels.

8. The electric motor driven cycle of claim 5 further comprising a motor support tube coupled to the frame, the motor support tube supporting the electric motor.

9. The electric motor driven cycle of claim 8 further comprising a motor support ring coupled to the electric motor.

10. An electric motor driven cycle, comprising:
a rear wheel;
an electric motor;
means for transmitting power from the electric motor to the rear wheel; and
a swing arm coupled between the electric motor and the rear wheel.

11. The electric motor driven cycle of claim 9 wherein the electric motor comprises a drive shaft and the rear wheel comprises an axle, the swing arm being coupled between the drive shaft and the axle.

12. The electric motor driven cycle of claim 11 wherein the electric motor further comprises a pulley at a distal end of the drive shaft, the rear wheel further comprises a drive wheel at a distal end of the axle, and the means for transmitting power from the electric motor to the rear wheel comprises a drive belt coupled between the pulley and drive wheel.

13. The electric motor driven cycle of claim 10 further comprising a frame supporting the electric motor.

14. The electric motor driven cycle of claim 13 further comprising a shock absorber coupled between the frame and the swing arm.

15. The electric motor driven cycle of claim 13 further comprising a front wheel, the frame being suspended between the front and rear wheels.

16. The electric motor driven cycle of claim 13 further comprising means for securing the electric motor to the frame.

17. The electric motor driven cycle of claim 16 when the means for securing the electric motor to the frame comprises a motor support tube coupled to the frame, the motor support tube supporting the electric motor.

18. The electric motor driven cycle of claim 17 wherein the means for securing the electric motor to the frame further comprises a motor support ring coupled to the electric motor.

19. An electric motor driven cycle, comprising:
a rear wheel;
an electric motor configured to deliver power to the rear wheel;
a swing arm cantilevered from the electric motor and supporting the rear wheel.

20. The electric motor driven cycle of claim 19 wherein the electric motor comprises a drive shaft and the rear wheel comprises an axle, the swing arm being cantilevered from the drive shaft and supporting the axle.

21. The electric motor driven cycle of claim 20 wherein the electric motor further comprises a pulley at a distal end of the drive shaft, and the rear wheel further comprises a drive wheel at a distal end of the axle, the electric motor driven cycle further comprising means for transmitting power from the pulley to the drive wheel.

22. The electric motor driven cycle of claim 21 wherein the means for transmitting power from the pulley to the drive wheel comprises a drive belt.

23. The electric motor driven cycle of claim 19 further comprising a frame supporting the electric motor.

24. The electric motor driven cycle of claim 23 further comprising a shock absorber coupled between the frame and the swing arm.

25. The electric motor driven cycle of claim 23 further comprising a front wheel, the frame being suspended between the front and rear wheels.

26. The electric motor driven cycle of claim 23 further comprising a motor support tube coupled to the frame, the motor support tube supporting the electric motor.

27. The electric motor driven cycle of claim 26 further comprising a motor support ring coupled to the electric motor.
